(19) United States
(12) Patent Application Publication
(10) Pub. No.: US 2009/0225448 A1
(43) Pub. Date: Sep. 10, 2009

(54) Magnifier

(76) Inventor: Stephen Albert Johnston, Tempe, AZ (US)

Correspondence Address: Stephen Albert Johnston, 8606 S. Dorsey Lane, Tempe, AZ, 85284, US

(21) Appl. No.: 12/392,530

(22) Filed: Feb. 25, 2009

Related U.S. Application Data
(60) Provisional application No. 61/033,868, filed on Mar. 5, 2008.

(51) Int. Cl. G02B 27/02; G02B 25/00

(52) U.S. Cl. 359/804; 359/813

(57) ABSTRACT

A magnifier is provided for magnifying textual, graphic, or other material associated with a container or other object.

### CROSS-REFERENCE TO RELATED APPLICATIONS

This application claims the benefit of U.S. Provisional Application No. 61/033,868 filed Mar. 5, 2008.

### STATEMENT REGARDING FEDERALLY SPONSORED RESEARCH & DEVELOPMENT

Not applicable

### BACKGROUND

### Description of Prior Art

Product containers are increasingly required to offer textual or graphic material providing instructions for the use of the product, information about the composition of the product, and other information important to the user. It may be necessary or desirable for the textual or graphic material to contain characters or symbols of more than one size. A problem that often arises, particularly with small containers, is that if the textual or graphic material is made small enough to fit in the space available, it will be so small that users will be unable to read it comfortably, and/or may misread or misunderstand the information presented. Previous attempts to solve the problem include those described in U.S. Pat. No. 6,621,629 (Blumenthal et al.), involving a flexible unit that wraps around a container and incorporates a magnifying element; and in US Pub. No. 2005/0211656 (Muir), disclosing a container cap incorporating a “flip-top” magnifying element. These devices are inadequate as general solutions to the problem of facilitating the reading of fine print and graphics on containers. The Muir device requires that the container cap be removed and separately held in order to align it for optimal magnification and viewing. The Blumenthal device is likewise not integral to the container and is held by friction over the exterior of the container, potentially allowing it to be removed and lost, and potentially abrading the image on the label as the device is repeatedly moved, and is suitable only for containers whose labels are disposed on a cylindrical vessel of a circumference to which the device is capable of conforming. Neither device provides for more than a single level of magnification.

### SUMMARY OF THE INVENTION

The disclosures hereof provide an elegant and practical solution to the problem of making accessible fine print or graphics or other material presented on a container label, on a contained product, or otherwise associated with a container. The disclosures hereof can readily be adapted to provide a way for users to magnify text or graphics associated with presentation modalities other than container labels, such as, by way of non-limiting example, menus, instruction booklets, computer screens, instrument readouts, and packages containing products such as stamps or coins.

In a first aspect, there is provided a magnifier for magnifying textual, graphic, or other material associated with an object, comprising:
A bearing member for movably engaging the object, and
a traveler extending from the bearing member and comprising a magnifying element, whereby the magnifying element is disposed in a plurality of selectable positions suitable for viewing a magnified image of the textual, graphic, or other material associated with the object.

In a second aspect, there is provided a magnifier for magnifying textual, graphic, or other material associated with a container having a neck, comprising:
a bearing member for rotatably engaging the neck of the container, and
a traveler extending from the bearing member and comprising a magnifying element whereby the magnifying element is disposed in a plurality of selectable positions suitable for viewing a magnified image of the textual, graphic, or other material associated with the object.

In a third aspect, there is provided a magnifier according to the first or second aspect, further comprising an extension member whereby the magnifying element is positioned at a desired distance and/or orientation with respect to the matter desired to be magnified.

In a fourth aspect, there is provided the magnifier of any of the first, second, or third aspects, further comprising a container or object with respect to which the magnifier is disposed.

It is an object of certain embodiments of the invention to provide a magnification device suitable for use with a medicine bottle, thereby improving patient compliance and avoiding dosing errors by making the label more accessible to patients, particularly those of diminished eyesight.

It is an object of certain embodiments of the invention to provide a device capable of simple manufacture, with some embodiments capable of being manufactured in a single piece.

It is an object of certain embodiments of the invention to provide a device capable of providing more than one level of magnification and disposing the regions having particular levels of magnification in correct juxtaposition with the text or other material to be magnified corresponding to each level of magnification.

It is an object of certain embodiments of the invention to provide, for use with a container, a magnification device that is movably associated with the container in such a way as to permit movement of the magnifying element over the material desired to be magnified.

It is an object of certain embodiments of the invention to provide, for use with a container, a magnification device that is movably associated with the container in such a way as to avoid abrading or damaging the container or its label by repeated movement.

It is an object of certain embodiments of the invention to provide, for use with a container or other object, a magnification device that is associated with the container in such a way as to reasonably avoid inadvertent removal and/or loss of the magnifier.

It is an object of certain embodiments of the invention to provide, for use with a container or other object, a magnification device that is movably associated with the container or other object in such a way as to generally constrain the magnifying element with respect to positions at which it corresponds to the text or other material intended to benefit from magnification, at a distance and orientation suitable for such magnification, in such a way as to facilitate one-handed use if desired.

It is an object of certain embodiments of the invention to provide an inexpensive and disposable magnification device that can be readily employed in a variety of consumer settings wherever it is desired to provide text, graphics, or other material for perusal by a user, together with a means of magnifying it.

### DESCRIPTION OF THE DRAWINGS

FIG. 1 shows an embodiment of a magnifier according to the disclosures hereof in association with a bottle-type container.

FIG. 2 shows an embodiment of a magnifier according to the disclosures hereof in association with a bottle-type container and having a magnifying element having two distinct regions differing in magnification.

FIG. 3 shows an embodiment of a magnifier according to the disclosures hereof in association with a bottle-type container and incorporating an extension member.

FIG. 4 shows an embodiment of a magnifier according to the disclosures hereof in association with a textual display.

FIG. 5 shows an embodiment of a magnifier according to the disclosures hereof in association with a container containing an object desired to be magnified.

FIG. 6 shows an embodiment of a magnifier according to the disclosures hereof in association with a container having a lid.

### DETAILED DESCRIPTION OF THE INVENTION

In a first aspect, there is provided a magnifier for magnifying textual, graphic, or other material associated with a container, comprising:
A bearing member for movably engaging the object, and
a traveler extending from the bearing member and comprising a magnifying element, whereby the magnifying element is disposed in a plurality of selectable positions suitable for viewing a magnified image of the textual, graphic, or other material associated with the object.

The magnifier disclosed herein may be affixed to and/or engaged with an object (such as, by way of non-limiting example, a container) via a bearing member, which may engage the object in any manner operable to position the traveler in such a way as to dispose the magnifying element in a position suitable for viewing under magnification textual, graphic, or other material associated with the object. The object may be any object having, containing, or associated with any text, graphics, or other visually discernable feature of which magnification is desired. In various embodiments the object may be a container such as a medicine bottle having an external or internal label; a textual display such as a menu, booklet, clipboard, or instruction placard; an instrument display; a package or display containing one or more objects of which magnification is desired such as coins or stamps; a keyboard or keypad; a video display such as the display of a mobile telephone or player; or any other object having or associated with a magnifiable component or region of interest.

In various embodiments, the bearing member may engage the object directly or via one or more other members or structures. In various embodiments, the bearing member may be integral with the traveler. In various embodiments, the bearing member and traveler may be distinct structural components and may be in direct contact each with the other, or may be connected via one or more other members or structures. The structure, composition, and disposition of the bearing member may be of any kind operable to provide the desired engagement and range of motion; many such configurations will be apparent to a person having ordinary skill in the art. In various embodiments, the bearing member rotates, slides, swivels, or otherwise moves directly upon a surface of the object or container. In various embodiments, the bearing member rotates, slides, swivels, or otherwise moves upon another element or structure provided for the purpose, which is in turn affixed to or associated with the object or container. In various embodiments, the bearing member comprises a movable joint such as, by way of non-limiting example, a hinge. In various embodiments, the bearing member comprises a collar or ring that is disposed over a neck or groove of the object and capable of rotation thereupon. In various embodiments, the bearing member comprises a slide that is disposed on a track on or affixed to the object in such a way as to allow translational movement. In various embodiments, the bearing member comprises a structure having a hole that mates with a pin, rivet, or other fastener, permitting rotation thereabout. In various embodiments, the bearing member comprises a pin, rivet, or other fastener, that mates with a hole on or in the object or a structure affixed thereto, and is free to rotate therein.

The traveler may be of any structure, composition, and disposition with respect to the bearing member, operable to position the magnifying element in the desired positions. In various embodiments the traveler is integral with the bearing member. In various embodiments, the traveler is a distinct structure and is affixed to the bearing member directly. In various embodiments, the traveler is a distinct structure and is affixed to one or more other elements that are affixed to the bearing member. In various embodiments the traveler is rigidly affixed to the bearing member, thereby constraining the movement of the traveler with respect to the object to a limited range of positions as accessible by movement of the bearing member. In various embodiments, the traveler is affixed to the bearing member in a fully or partially flexible manner, permitting unconstrained or partially constrained movement of the traveler in one or more dimensions or about one or more axes of rotation.

The magnifying element may be of any structure, composition, and disposition with respect to the traveler, operable to provide optical magnification or other desired diffraction or image modification of a region of the object or container, a label or other entity disposed thereon, or an object contained therein. In various embodiments, the traveler is made in whole or part of a transparent or translucent material such as plastic and the magnifying element is integral with the traveler and has a shape suitable for providing magnification. In various embodiments, the magnifying element is a component distinct from the traveler and is affixed thereto, rigidly or flexibly, directly or via one or more other elements or compositions. In various embodiments, the magnifying element has cylindrical curvature with respect to an axis parallel to a longitudinal axis of the traveler. In various embodiments, the magnifying element has spherical or other curvature, and/or has cylindrical curvature with respect to a desired axis. In various embodiments, the magnifying element comprises a sheet magnifier, Fresnel lens, or other light-diffracting structure operable to produce magnification or other desired diffraction of the image. In various embodiments, the magnifying element comprises a single lens or other integral optical unit. In various embodiments, the magnifying element comprises a plurality of lenses. In various embodiments, the traveler comprises two or more magnifying elements, which may be of the same or similar structure and/or magnification properties, or may be of different structure and/or magnification properties. In various embodiments, the magnifying element comprises geometric, optical, or other properties that vary along one or more spatial dimensions, thereby providing a plurality or gradation of diffractive properties over the spatial extent of the magnifying element. In various embodiments, the magnifying element has a geometry, structure, and position providing an enlarged virtual image, with or without distortion, aberration, filtering, or other modification, of the region over which it is disposed.

The bearing member, traveler, and magnifying element, together with such other structures or members as may be provided for joining them one with another and/or for engaging with the object, are disposed in such a way as to position the magnifying element in relationship to a plurality of regions desired to be magnified, at a distance therefrom and orientation with respect thereto such that a reasonably informative magnified image thereof may be observed. The regions desired to be magnified may be regions of the surface of the object itself, regions of a label or other matter affixed to or associated with the object; regions of another object contained by the object; or any other regions of interest associated with the object and capable of visual observation under magnification. In various embodiments all or part of the inner surface of the traveler is in contact with the object. In various embodiments the traveler is positioned with a gap between all or part of the traveler and the surface of the object. It will be apparent to a person having ordinary skill in the art that the optimal positioning and orientation of the magnifying element with respect to the object will depend in part upon the chosen geometric, optical, and other properties of the magnifying element, and that all of these may be adjusted to provide the kind and degree of magnification desired.

In a second aspect, there is provided a magnifier for magnifying textual, graphic, or other material associated with a container having a neck, comprising:
a bearing member for rotatably engaging the neck of the container, and
a traveler extending from the bearing member and comprising a magnifying element whereby the magnifying element is disposed in a plurality of selectable positions suitable for viewing a magnified image of the textual, graphic, or other material associated with the object.

In various embodiments, the magnifier is associated with a container, such as, by way of non-limiting example, a medicine bottle, that has a neck, which may comprise a region, of a container of generally cylindrical cross section, having locally reduced diameter. In various embodiments, the neck comprises the neck of a bottle-type container, which may be adjacent to the lid of the container. In various embodiments, the neck comprises a circumferential groove or depression wherein the diameter of the container is reduced relative to adjacent parts of the container. In various embodiments, the neck comprises a circumferential groove or depression in the lid or another component of the container distinct from the body thereof. In various such embodiments, the bearing member may comprise a ring or collar disposed around the neck of the container, allowing the bearing member to rotate about the longitudinal axis of the container or of the part of the container comprising the neck or groove. In various such embodiments, the traveler extends from the bearing member in a longitudinal direction with respect to the container, and/or in a generally perpendicular direction with respect to the plane of rotation of the bearing member, so that upon rotation of the bearing member, the magnifying element is positioned over selected regions of the container surface.

In a third aspect, there is provided a magnifier according to the first or second aspect, further comprising an extension member whereby the magnifying element is positioned at a desired distance and/or orientation with respect to the matter desired to be magnified.

In various embodiments, the traveler is affixed to the bearing member via a malleable or deformable structure or composition, thereby enabling stable repositioning of the traveler with respect to the bearing member, such as, by way of non-limiting example, by bending a connecting structure comprising a ductile metal, or by bending, stretching, or extending a deformable plastic connecting structure. In various embodiments, the traveler is affixed to the bearing member via an extension member, such as, by way of non-limiting example, an extendable plastic accordion structure, enabling stable repositioning of the traveler with respect to the bearing member and/or stable positioning of the magnifying element at a desired distance from the object. The extension member may be a distinct structure component or may be integral with the bearing member, traveler, or both.

In a fourth aspect, there is provided the magnifier of any of the first, second, or third aspects, further comprising a container or object with respect to which the magnifier is disposed. In various embodiments, the magnifier is provided as a separate product to be assembled to the container or other object by the user. In various embodiments, the magnifier and the container or other object are provided together as an assembly. In various embodiments, there is provided the magnifier and the container or other object, packaged or distributed together but fully or partially unassembled one from the other, for further assembly thereafter. In various embodiments, there is provided the magnifier, the container, and the contents of the container, with the magnifier and container provided as an assembly, and with the contents disposed in the container. In various embodiments, there is provided the magnifier, and the container together with its contents, with the magnifier provided and/or distributed together with but fully or partially disassembled from the container and its contents.

### EXAMPLE 1

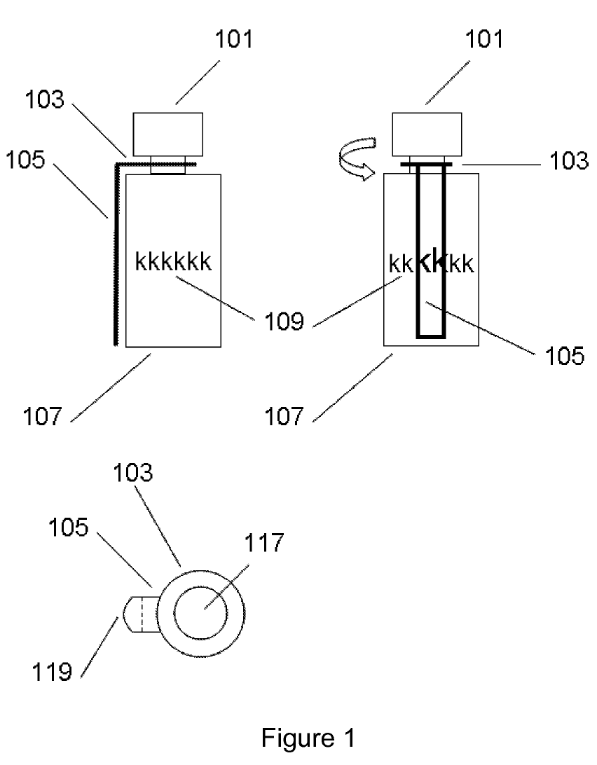

In an illustrative non-limiting example as depicted schematically in FIG. 1, the magnifier is provided in association with a bottle-type container 107 having a lid 101 and a neck region, adjacent to the lid, around which the bearing element 103 is disposed with the neck region of the container extending through a circular hole 117 provided in the bearing member 103. In this example the bearing member 103 and traveler 105 are integral and molded as a single unit from a transparent plastic material, which is relatively rigid, thereby maintaining the traveler 105 at an approximately fixed distance from the surface of the container. The magnifying element is integral with the traveler 105, with a surface of the magnifying element 119 (which may be the inner surface, outer surface, or both) being curved in a manner operable to provide magnification. The bearing member 103 is free to rotate about the neck of the container, allowing the magnifying element 105 to be positioned over the desired region of the container label 109.

### EXAMPLE 2

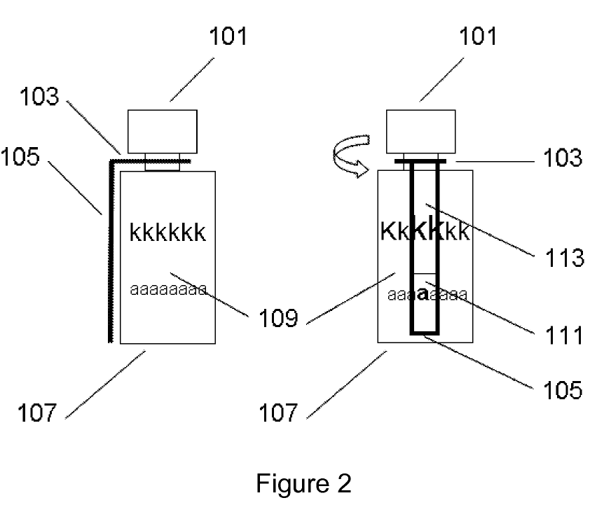

In an illustrative non-limiting example as depicted schematically in FIG. 2, the magnifier is provided in association with a bottle-type container generally as described in Example 1. In this example, the traveler 105 comprises two magnifying elements 111, 113 each providing a different level of magnification suitable for magnifying different parts of the label 109 by different amounts.

### EXAMPLE 3

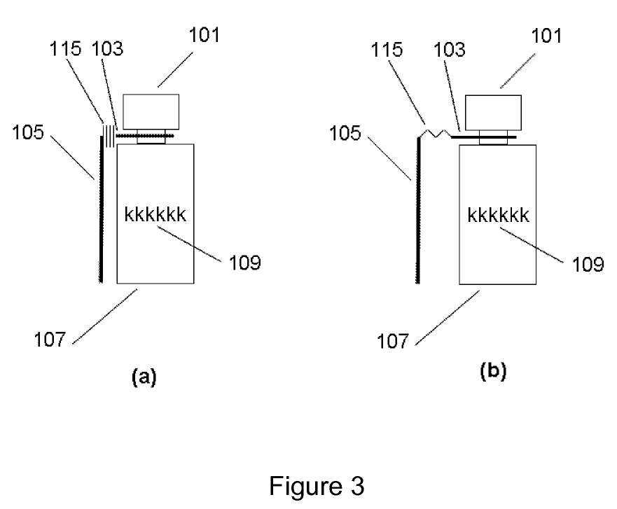

In an illustrative non-limiting example as depicted schematically in FIG. 3, the magnifier is provided in association with a bottle-type container generally as described in Example 1. In this example, the traveler 105 is affixed to the bearing member 103 via an extension member 115. The extension member 115 comprises a plastic accordion structure that is initially disposed in a collapsed configuration as shown in FIG. 3(a), can be extended as shown in FIG. 3(b) by pulling the traveler 105 outward from the body of the container 107, and tends to retain its shape and orientation after extension, thereby stably positioning the magnifying element at a desired distance and/or orientation with respect to the body of the container 107.

### EXAMPLE 4

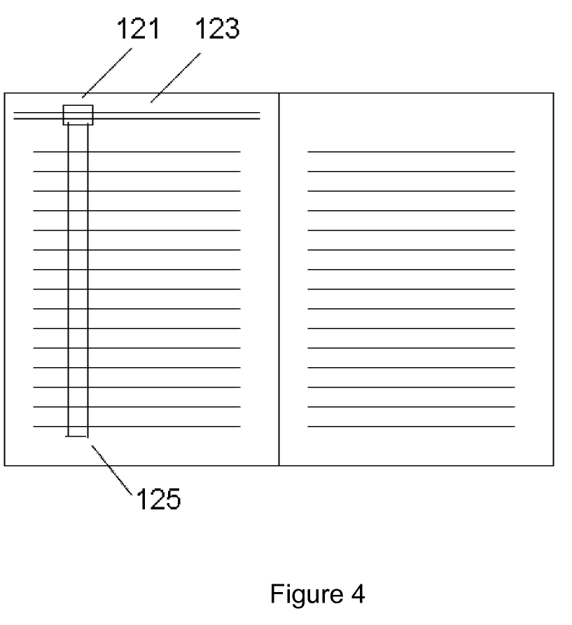

In an illustrative non-limiting example as depicted schematically in FIG. 4, the magnifier is provided in association with a textual or graphic display such as a menu or clipboard. In this example, the traveler 125 is affixed to a bearing member 121 comprising a slide, which is slidably engaged with a track 123 affixed to the display, allowing free lateral movement of the bearing member 121 along the track 123. The traveler 125 is molded from transparent plastic, shaped in such a way as to provide the desired magnification of the text or graphics over which it is positioned. The traveler and bearing member may be molded as a single integral unit, or may be distinct components affixed one to the other by heat, adhesive, or a fastener, or by a hinge allowing the traveler to be raised to facilitate turning of pages.

### EXAMPLE 5

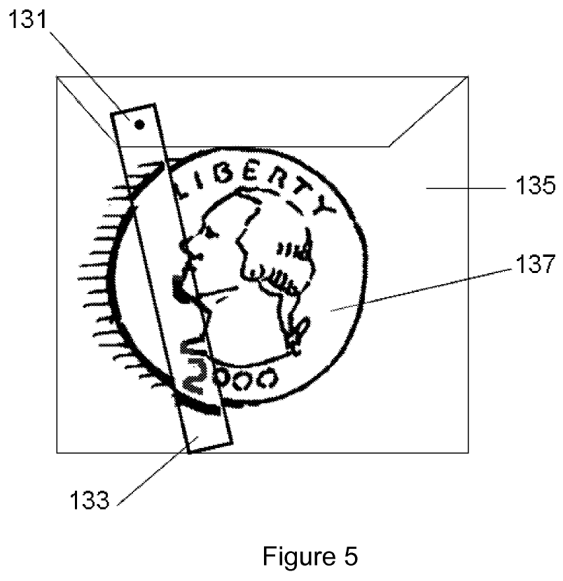

In an illustrative non-limiting example as depicted schematically in FIG. 5, the magnifier is provided in association with a package 135 for containing an object 137 whose magnification may be desired such as, by way of non-limiting example as depicted in FIG. 5, a coin. In this example, the bearing member comprises a rivet 131, and the traveler comprises a terminal region containing a hole through which the traveler 133 is affixed to the package 135 by the rivet 131, thereby allowing the traveler 133 to swivel about the rivet 131. The traveler 133 is molded from transparent plastic, shaped in such a way as to provide the desired magnification of the object 137 over which it is positioned.

### EXAMPLE 6

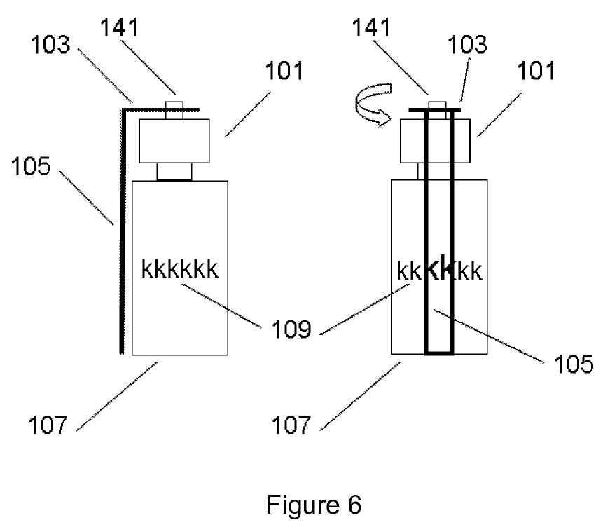

In an illustrative non-limiting example as depicted schematically in FIG. 6, the magnifier is provided in association with a bottle-type container 107 having a lid 101 with which the bearing member 103 is engaged via a pin 141 about which the bearing member is free to rotate. The pin 141 may be flanged or grooved to prevent disengagement of the bearing member 103. In some embodiments the bearing member may comprise a pin and engage a hole in the container lid 101 in which it is free to rotate.

### Conclusions, Ramifications, and Scope

The present invention is not limited in scope to the embodiments or examples disclosed above, which are intended as non-limiting illustrations of one or a few aspects of the invention, and any structures, compositions, and/or methods that are functionally equivalent to those described in the embodiments and examples are within the scope of the invention. Various other modifications of the invention in addition to those shown and described herein will be apparent to those skilled in the art from the foregoing description. Such modifications are intended to fall within the scope of the invention.

In the foregoing description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention.

The inventor is fully informed of the standards and application of the special provisions of 35 U.S.C. §112, ¶6. Thus, the use of the words “function,” “means” or “step” in the written description or claims is not intended to indicate a desire to invoke the special provisions of 35 U.S.C. §112, ¶6, to define the invention. To the contrary, if the provisions of 35 U.S.C. §112, ¶6 are sought to be invoked to define the invention or an element thereof, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventor not to invoke the provisions of 35 U.S.C. §112, ¶6. Moreover, even if the provisions of 35 U.S.C. §112, ¶6 are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are equivalent structures, material or acts for performing the claimed function, whether currently known or later developed.

1. A magnifier for magnifying textual, graphic, or other material associated with an object, comprising:
a bearing member for movably engaging the object, and
a traveler extending from the bearing member and comprising a magnifying element, whereby the magnifying element is disposed in a plurality of selectable positions suitable for viewing a magnified image of the textual, graphic, or other material associated with the object.

2. A magnifier for magnifying textual, graphic, or other material associated with a container having a neck, comprising:
a bearing member for rotatably engaging the neck of the container, and
a traveler extending from the bearing member and comprising a magnifying element, whereby the magnifying element is disposed in a plurality of selectable positions suitable for viewing a magnified image of the textual, graphic, or other material associated with the object.

3-7. (canceled)

8. The magnifier of claim 1, further comprising an extension member whereby the magnifying element is positioned at a desired distance and/or orientation with respect to the matter desired to be magnified.

9. The magnifier of claim 2, further comprising an extension member whereby the magnifying element is positioned at a desired distance and/or orientation with respect to the matter desired to be magnified.

10. The magnifier of claim 1, wherein the textual, graphic, or other material associated with the object comprises a label affixed to or associated with the object.

11. The magnifier of claim 2, wherein the textual, graphic, or other material associated with the object comprises a label affixed to or associated with the object.

12. The magnifier of claim 1, wherein the textual, graphic, or other material associated with the object comprises all or part of another object contained by the object.

13. The magnifier of claim 2, wherein the textual, graphic, or other material associated with the object comprises all or part of another object contained by the object.

14. The magnifier of claim 1, further comprising a container or object with respect to which the magnifier is disposed.

15. The magnifier of claim 2, further comprising a container or object with respect to which the magnifier is disposed.

16. The magnifier of claim 14, further comprising the contents of the container.

17. The magnifier of claim 15, further comprising the contents of the container.
